(19) United States
(12) Patent Application Publication
(10) Pub. No.: US 2017/0219460 A1
(43) Pub. Date: Aug. 3, 2017

(54) LIFE DETERMINING DEVICE AND LIFE DETERMINING METHOD

(71) Applicant: RENESAS ELECTRONICS CORPORATION, Tokyo (JP)

(72) Inventors: Takuya NAGASHIMA, Tokyo (JP); Yoshitaka TAKI, Tokyo (JP)

(21) Appl. No.: 15/422,089

(22) Filed: Feb. 1, 2017

(30) Foreign Application Priority Data
Feb. 2, 2016 (JP) 2016-017673

(51) Int. Cl. G01M 99/00

(52) U.S. Cl. CPC G01M 99/002

(57) ABSTRACT

A life determining device capable of performing life determination while suppressing a processing load is provided. A life determining device 1 includes a measured value acquiring unit 2 that acquires a measured value for a stressor at predetermined time intervals, an acceleration factor acquiring unit 3 that acquires a first acceleration factor, which is the ratio of a second life to a first life, at predetermined time intervals, and a life determining unit 5 that determines life expiration of a device whose life is to be determined by comparing a value obtained by multiplying an accumulated value of the first acceleration factor by a predetermined time with a second life. The acceleration factor acquiring unit 3 uses a look-up table 4 that stores a second acceleration factor for each predetermined value when it acquires the first acceleration factor.

### CROSS-REFERENCE TO RELATED APPLICATIONS

This application is based upon and claims the benefit of priority from Japanese patent application No. 2016-017673, filed on Feb. 2, 2016, the disclosure of which is incorporated herein in its entirety by reference.

### BACKGROUND

The present invention relates to a life determining device and a life determining method and relates to, for example, a life determining device and a life determining method that determine life using a measured value of a stressor of a device whose life is to be determined.

In recent years, it has been required to detect that a device, for example, in an automobile has become highly likely to have a failure and to prevent the failure in advance. A method of monitoring a state of degradation in a wear-out failure period in a bathtub curve is known as a method of detecting that the device has become highly like to have the failure.

Japanese Unexamined Patent Application Publication No. 2009-095143, for example, discloses a vehicle control device that uses a rotating electric machine as a drive source, in which a thermal history of a coil based on a predetermined temperature is accumulated using a temperature sensor, life is determined by the Arrhenius equation, and a load applied to the coil is reduced when the life expiration approaches. Further, Japanese Unexamined Patent Application Publication No. 2013-092405 discloses monitoring a temperature, a voltage, and a humidity, and determining life by the Eyring model based on the temperature, the voltage, and the humidity that have been monitored.

### SUMMARY

In the life determination disclosed in Japanese Unexamined Patent Application Publication No. 2009-095143 and Japanese Unexamined Patent Application Publication No. 2013-092405, however, it is required to perform an exponential operation using data such as a temperature in order to calculate life expiration. This causes a problem that the processing load increases.

The other problems of the related art and the novel characteristics of the present invention will be made apparent from the descriptions of the specification and the accompanying drawings.

According to an embodiment, a life determining device includes an acceleration factor acquiring unit that acquires a first acceleration factor, which is the ratio of a second life to a first life, using a look-up table at predetermined time intervals and a life determining unit that determines life expiration of a device whose life is to be determined by comparing a value obtained by multiplying an accumulated value of the first acceleration factor by a predetermined time with a second life.

According to the embodiment, it is possible to perform life determination while suppressing the processing load.

### BRIEF DESCRIPTION OF THE DRAWINGS

The above and other aspects, advantages and features will be more apparent from the following description of certain embodiments taken in conjunction with the accompanying drawings, in which:

FIG. 1 is a block diagram showing a general configuration example of a life determining device according to an embodiment;

FIG. 2 is a block diagram showing a configuration of a life determining device according to a first embodiment;

FIG. 3 is a block diagram showing a configuration of an operation unit according to the first embodiment;

FIG. 4 is a table showing a configuration of a look-up table according to the first embodiment;

FIG. 5 is a graph showing an example of division when a range of temperature values is divided at equal intervals;

FIG. 6 is a graph showing an example of division when the range of temperature values is divided so that an acceleration factor is divided at regular intervals;

FIG. 7 is a flowchart showing one example of an operation of the life determining device according to the first embodiment;

FIG. 8 is a table showing a configuration of a look-up table according to a second embodiment;

FIG. 9 is a block diagram showing a configuration of an operation unit according to a third embodiment; and

FIG. 10 is a flowchart showing one example of an operation of a life determining device according to the third embodiment.

### DETAILED DESCRIPTION

For the clarification of the description, the following description and the drawings may be omitted or simplified as appropriate. Further, each element shown in the drawings as functional blocks that perform various processing can be formed of a CPU, a memory, and other circuits in hardware and may be implemented by programs loaded in the memory in software. Those skilled in the art will therefore understand that these functional blocks may be implemented in various ways by only hardware, only software, or the combination thereof without any limitation. Throughout the drawings, the same components are denoted by the same reference symbols and overlapping descriptions will be omitted as appropriate.

Further, the aforementioned program can be stored and provided to a computer using any type of non-transitory computer readable media. Non-transitory computer readable media include any type of tangible storage media. Examples of non-transitory computer readable media include magnetic storage media (such as flexible disks, magnetic tapes, hard disk drives, etc.), optical magnetic storage media (e.g. magneto-optical disks), CD-ROM (compact disc read only memory), CD-R, CD-R/W, and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Further, sound waves or ultrasound waves may be used for communications. Transitory computer readable media can provide the program to a computer via a wired communication line (e.g. electric wires, and optical fibers) or a wireless communication line.

### <Outline of Embodiments>

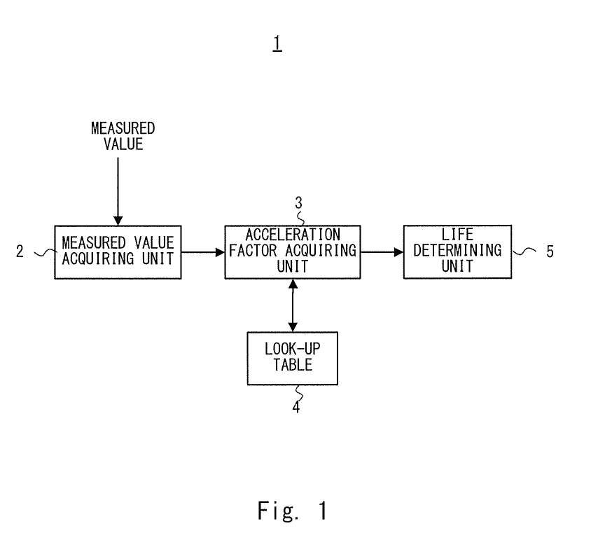

Before describing the details of embodiments, an outline thereof will be described. FIG. 1 is a block diagram showing a general configuration example of a life determining device 1 according to a first embodiment. The life determining device 1 is a device that determines life expiration of a device whose life is to be determined. Specifically, the life determining device 1 includes, as shown in FIG. 1, a measured value acquiring unit 2, an acceleration factor acquiring unit 3, a look-up table 4, and a life determining unit 5.

The measured value acquiring unit 2 acquires a measured value of a stressor of the device whose life is to be determined (hereinafter this device will be called a device to be determined) at predetermined time intervals. Specifically, the measured value acquiring unit 2 acquires, for example, measured values of the temperature and the voltage of the device to be determined. The measured value acquiring unit 2 may acquire a measured value of another stressor as a measured value of the stressor. The measured value acquiring unit 2 may acquire, for example, a measured value of the humidity of the device to be determined or may acquire a measured value of the current of the device to be determined. Further, the measured value acquiring unit 2 may acquire a measured value of each of a plurality of types of stressors or may acquire a measured value of only one stressor. By applying the measured value of the humidity or the current, besides the measured values of the temperature and the voltage, to the Eyring model that will be described later, the life of a device to be determined 9 can be determined more accurately.

The acceleration factor acquiring unit 3 acquires a first acceleration factor, which is the ratio of a second life to a first life, at the predetermined time intervals. The first life is a life of the device to be determined when the value of the stressor continues to be the measured value acquired by the measured value acquiring unit 2. Further, the second life is a life of the device to be determined when the value of the stressor continues to be a predetermined reference value. The acceleration factor acquiring unit 3 uses the look-up table 4 when it acquires the first acceleration factor.

The look-up table 4 is a table that stores a second acceleration factor. The second acceleration factor is the ratio of the aforementioned second life to the life of the device to be determined when the value of the stressor of the device to be determined continues to be a predetermined value. The look-up table 4 stores the second acceleration factor for every predetermined value. The acceleration factor acquiring unit 3 acquires the second acceleration factor stored in the look-up table 4 for the predetermined value corresponding to the measured value as the aforementioned first acceleration factor.

The life determining unit 5 compares a value obtained by multiplying the accumulated value of the first acceleration factor acquired by the acceleration factor acquiring unit 3 by the aforementioned predetermined time with the second life to determine the life expiration of the device to be determined.

According to the life determining device 1, the acceleration factor acquiring unit 3 acquires the acceleration factor from the look-up table 4. Accordingly, the life determining device 1 does not need to sequentially execute an exponential operation. The life determining device 1 is therefore able to perform life determination while suppressing the processing load.

### First Embodiment

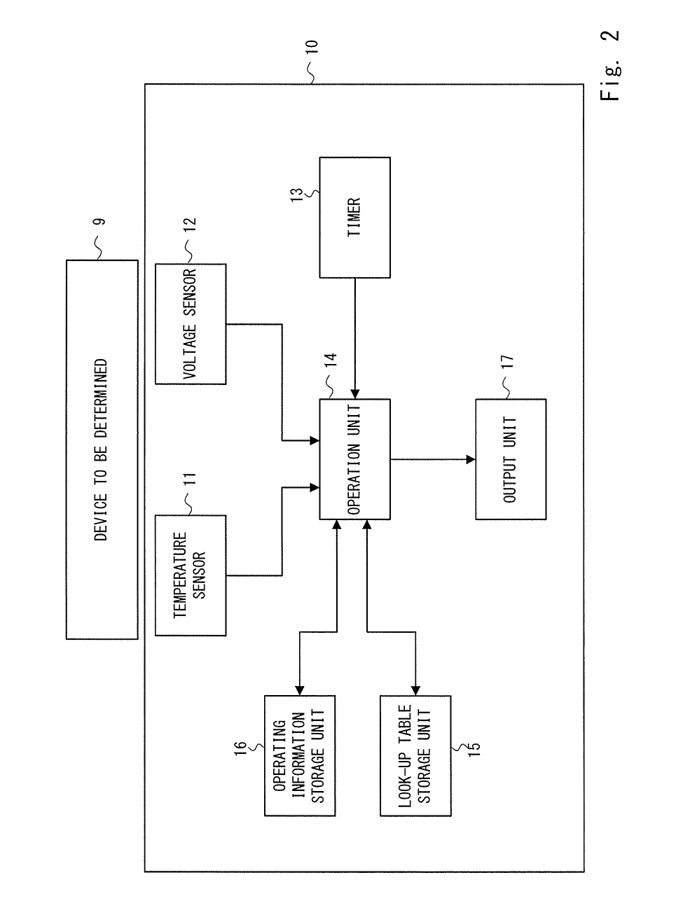

Hereinafter, details of a first embodiment will be described. FIG. 2 is a block diagram showing a configuration of a life determining device 10 according to the first embodiment. The life determining device 10 is a device that determines the life of a device to be determined 9 based on measured values of the temperature and the voltage of the device to be determined 9. The life determining device 10 includes, as shown in FIG. 2, a temperature sensor 11, a voltage sensor 12, a timer 13, an operation unit 14, a look-up table storage unit 15, an operating information storage unit 16, and an output unit 17.

The temperature sensor 11 is a sensor that measures the temperature of the device to be determined 9 and outputs the measured value to the operation unit 14. The temperature sensor 11 is formed of, for example, a thermistor or the like, measures the temperature around a predetermined circuit in the device to be determined 9, and outputs the measured value to the operation unit 14. The voltage sensor 12 is a sensor that measures the voltage of the device to be determined 9 and outputs the measured value to the operation unit 14. The voltage sensor 12 detects, for example, the voltage of a predetermined circuit (e.g., power supply voltage). The timer 13 counts time and outputs the time to the operation unit 14.

The operation unit 14 is formed of, for example, a central processing unit (CPU), a memory and the like. The CPU executes a program stored in the memory, whereby each configuration that will be described later is formed. The operation unit 14 carries out operations regarding the life of the device to be determined 9 using the look-up table 4 stored in the look-up table storage unit 15.

The look-up table storage unit 15 is a storage apparatus that stores the aforementioned look-up table 4. The operating information storage unit 16 is a storage apparatus that stores the history of the acceleration factors obtained at every predetermined time interval. This history is output from the operation unit 14 as operating information of the device to be determined 9. The look-up table storage unit 15 and the operating information storage unit 16 are each formed of, for example, a nonvolatile memory. While the look-up table storage unit 15 and the operating information storage unit 16 are provided separately from the operation unit 14 in the configuration example shown in FIG. 2, one or both of them may be formed as the memory in the operation unit 14.

The output unit 17 is an output interface to output information to another device. The output unit 17 is connected, for example, to a display device such as a display, a communication network or the like.

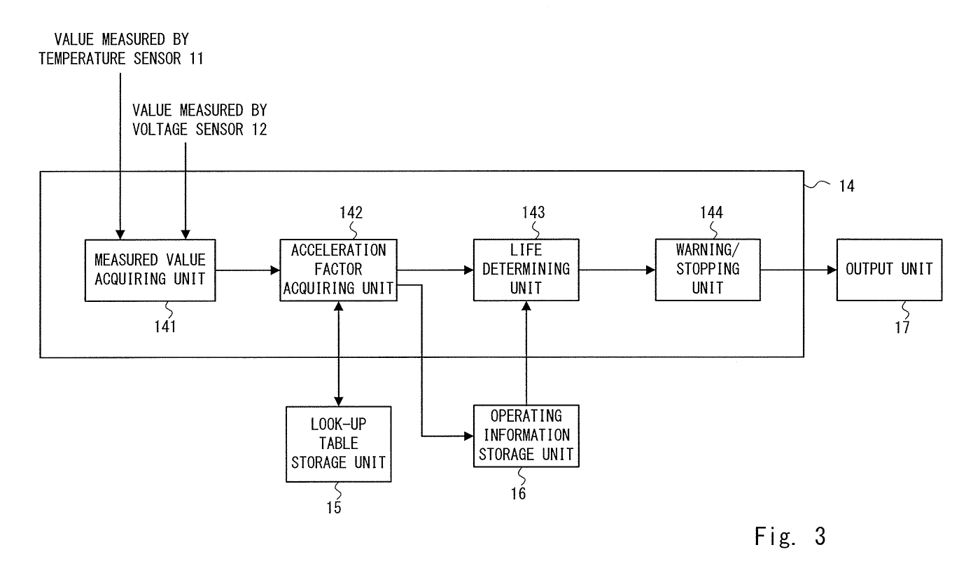

Next, a configuration of the operation unit 14 will be described. FIG. 3 is a block diagram showing the configuration of the operation unit 14. The operation unit 14 includes a measured value acquiring unit 141, an acceleration factor acquiring unit 142, a life determining unit 143, and a warning/stopping unit 144.

The measured value acquiring unit 141 corresponds to the aforementioned measured value acquiring unit 2 and acquires the temperature measured by the temperature sensor 11 and the voltage measured by the voltage sensor 12 every time the timer 13 counts a time interval t. While the measured value acquiring unit 141 acquires the measured values of the temperature and the voltage in this embodiment, the measured value acquiring unit 141 may acquire a measured value of another stressor as described above. In such a case, the life determining device 10 further includes a sensor that measures the value of another stressor.

The acceleration factor acquiring unit 142 corresponds to the aforementioned acceleration factor acquiring unit 3 and acquires the first acceleration factor, which is the ratio of the second life to the first life, by referring to the look-up table 4 stored in the look-up table storage unit 15 every time the timer 13 counts the time interval t.

The life determining unit 143 corresponds to the aforementioned life determining unit 5 and determines the life expiration of the device to be determined 9 by determining whether the value obtained by multiplying the accumulated value of the acceleration factors acquired by the acceleration factor acquiring unit 142 at every time t by the time t exceeds a predetermined threshold of the life.

The value obtained by multiplying the accumulated value of the acceleration factors by the time t corresponds to the cumulative usage time of the device to be determined 9 when the device to be determined 9 is used under a reference circumstance. That is, this multiplied value is a value obtained by converting the actual cumulative usage time into the cumulative usage time under the reference circumstance. The reference circumstance means a circumstance in which each of the values of the stressors to be acquired by the measured value acquiring unit 141 is a predetermined reference value. The life determining unit 143 transmits, when the cumulative usage time under the reference circumstance after the conversion has exceeded the predetermined threshold, a signal indicating that the cumulative usage time under the reference circumstance has exceeded the threshold to the warning/stopping unit 144.

The warning/stopping unit 144 performs control to issue a warning to a user or to stop the operation of the device to be determined 9. The warning/stopping unit 144 performs control, for example, to provide a warning display on a display (not shown) or the like via the output unit 17. Further, the warning/stopping unit 144 transmits a stop signal that instructs the device to be determined 9 to stop the operation to the device to be determined 9 via the output unit 17. The warning/stopping unit 144 may perform both the operation of issuing the warning and that of stopping the operation of the device to be determined 9.

Hereinafter, a method of determining the life of the device to be determined 9 according to the aforementioned configuration will be described in detail.

The Eyring model is typically known regarding life prediction. The Eyring model is expressed as shown in the following Expression (1).

$$K = a ( \frac{k T}{h} ) \cdot exp ( \frac{- {E}_{a}}{k T} ) \cdot {S}^{n} \qquad ( 1 )$$

In Expression (1), K is a reaction speed, a and n are constants, h is a Planck's constant, S is a stressor other than the temperature, k is a Boltzmann constant, T is an absolute temperature, and Eₐ is an activation energy (constant). Further, in this embodiment, T corresponds to the value measured by the temperature sensor 11.

Since the life L is in inverse proportion to the reaction speed K, by calculating the inverse number in Expression (1), the following Expression (2) is derived.

$$L = A exp ( \frac{{E}_{a}}{k T} ) \cdot {S}^{b} \qquad ( 2 )$$

In Expression (2), L is the life and A and b are constants. In this embodiment, the voltage V, which is a stressor other than the temperature, is in inverse proportion to the life L. Accordingly, Expression (2) above is changed as shown in the following Expression (3) using a constant B. In this embodiment, V corresponds to the value measured by the voltage sensor 12.

$$L = A exp ( \frac{{E}_{a}}{k T} ) \cdot exp ( \frac{B}{V} ) \qquad ( 3 )$$

The constants A, B, and Eₐ can be specified from results of acceleration tests performed under a plurality of different conditions in which temperature conditions and voltage conditions are changed. When the values of the respective constants are thus defined, the life of the device to be determined 9 when the device to be determined 9 is used in the reference circumstance can be calculated from Expression (3). That is, when the temperature in the reference circumstance, that is, the reference temperature, is denoted by T_{typ}, and the voltage in the reference circumstance, that is, the reference voltage, is denoted by V_{typ}, the life L (T_{typ},V_{typ}) of the device to be determined 9 when the device to be determined 9 continues to be used in the reference circumstance is calculated from Expression (3). The aforementioned second life corresponds to the life L (T_{typ},V_{typ}).

In a similar way, the life L (Tₓ,V_{y}) of the device to be determined 9 when the device to be determined 9 continues to be used under a circumstance in which the temperature is Tₓ and the voltage is V_{y} is also calculated from Expression (3). The aforementioned first life corresponds to the life L (Tₓ,V_{y}). The value of the stressor under the reference circumstance, that is, the values of the temperature and the voltage in this embodiment, may be a desired value. The reference temperature T_{typ} may be, for example, a desired value from the lower-limit value to the upper-limit value of a guaranteed temperature as a product of the device to be determined 9. The reference temperature T_{typ} may be equal to or smaller than the lower-limit value or may be equal to or larger than the upper-limit value of the guaranteed temperature. In a similar way, the reference voltage V_{typ} may be, for example, a desired value from the lower-limit value to the upper-limit value of a guaranteed voltage as a product of the device to be determined 9. The reference voltage V_{typ} may be equal to or smaller than the lower-limit value or may be equal to or larger than the upper-limit value of the guaranteed voltage.

The acceleration factor L_{ac} (Tₓ,V_{y}), which is the ratio of the life L (T_{typ},V_{typ}) of the device to be determined 9 when the device to be determined 9 continues to be used in the reference circumstance to the life L (Tₓ,V_{y}) of the device to be determined 9 when the device to be determined 9 continues to be used in an environment in which the temperature is Tₓ and the voltage is V_{y}, is expressed as shown in Expression (4) below. The aforementioned first acceleration factor corresponds to the acceleration factor L_{ac} (Tₓ,V_{y}).

$$\begin{matrix}{L}_{ac} ( {T}_{x} , {V}_{y} ) = \frac{L ( {T}_{typ} , {V}_{typ} )}{L ( {T}_{x} , {V}_{y} )} \\ = exp ( ( \frac{{E}_{a}}{k} ) ( \frac{1}{{T}_{typ}} - \frac{1}{{T}_{x}} ) ) \cdot ( B ( \frac{1}{{V}_{typ}} - \frac{1}{{V}_{y}} ) )\end{matrix} \qquad ( 4 )$$

The acceleration factor acquiring unit 142 acquires the value shown in Expression (4). Since the operation shown in Expression (4) includes the exponential operation (exp), if the acceleration factor acquiring unit 142 performs the operation at every time t, this increases the processing load. Accordingly, in this embodiment, the acceleration factor acquiring unit 142 acquires the acceleration factor stored in the look-up table 4.

Now, a configuration of the look-up table 4 according to this embodiment will be described. The look-up table 4 stores the acceleration factor expressed as the ratio of the second life to the life of the device to be determined 9 when the value of the stressor of the device to be determined 9 continues to be the predetermined value. The acceleration factor stored in the look-up table 4 may be called the second acceleration factor.

The look-up table 4 stores the second acceleration factor for every predetermined value. Specifically, the look-up table 4 stores, as the second acceleration factor for each value that belongs to a range of divided values obtained by dividing a range of values from a first value to a second value of the stressor of the device to be determined 9, one second acceleration factor for a predetermined value that belongs to the range of the divided values for each of the ranges of the divided values. It is therefore possible to suppress the size of the look-up table 4. In this embodiment, the first value is the lower-limit value of the guaranteed temperature or the lower-limit value of the guaranteed voltage of the device to be determined 9 as a product and the second value is the upper-limit value of the guaranteed temperature or the upper-limit value of the guaranteed voltage of the device to be determined 9 as a product. By associating the upper and lower limits of the guaranteed value with the value of the stressor in the look-up table 4, the device to be determined 9 can be guaranteed while suppressing the size of the look-up table 4. Alternatively, values other than the upper limit or the lower limit of the guaranteed value may be employed as the first value and the second value.

The look-up table 4 stores, as the acceleration factor for each range of the divided values, the maximum value of the acceleration factors for the values that belong to the range of the divided values. That is, when a range of divided values is a range of values from values p to q, the look-up table 4 associates one acceleration factor value with a desired value r that is larger than the value p but is equal to or smaller than the value q. This value of the acceleration factor that is associated with the desired value r is a maximum value of results of a calculation when the acceleration factor is calculated for a desired value of the range of the divided values. In this way, the look-up table 4 stores the maximum acceleration factor for each range of the divided values, whereby it is possible to prevent an underestimation of the usage time of the device to be determined 9. It is therefore possible to determine the life more safely.

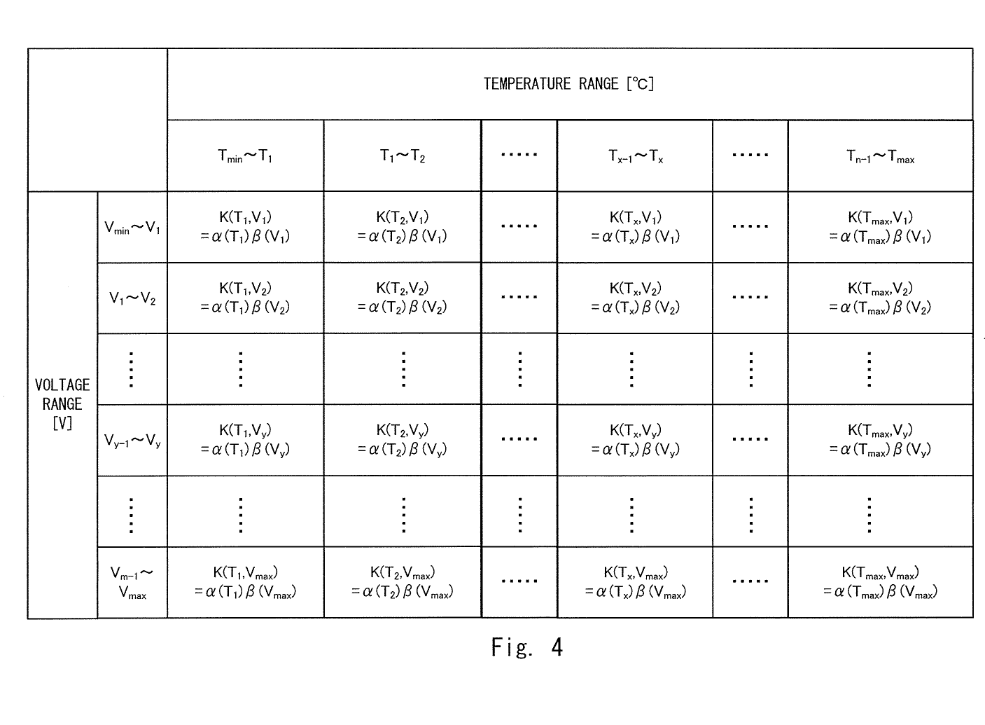

FIG. 4 is a table showing a configuration of the look-up table 4 according to this embodiment. As shown in FIG. 4, the temperature from a lower-limit value Tₘᵢₙ of the guaranteed temperature to an upper-limit value Tₘₐₓ of the guaranteed temperature is divided into n ranges of values. Further, the value from a lower-limit value Vₘᵢₙ of the guaranteed voltage to an upper-limit value Vₘₐₓ of the guaranteed voltage is divided into m ranges of values. The acceleration factor acquiring unit 142 specifies which range in the look-up table 4 the measured value of the temperature and the measured value of the voltage acquired by the measured value acquiring unit 141 belong to and acquires the acceleration factor stored in association with the range of values that has been specified.

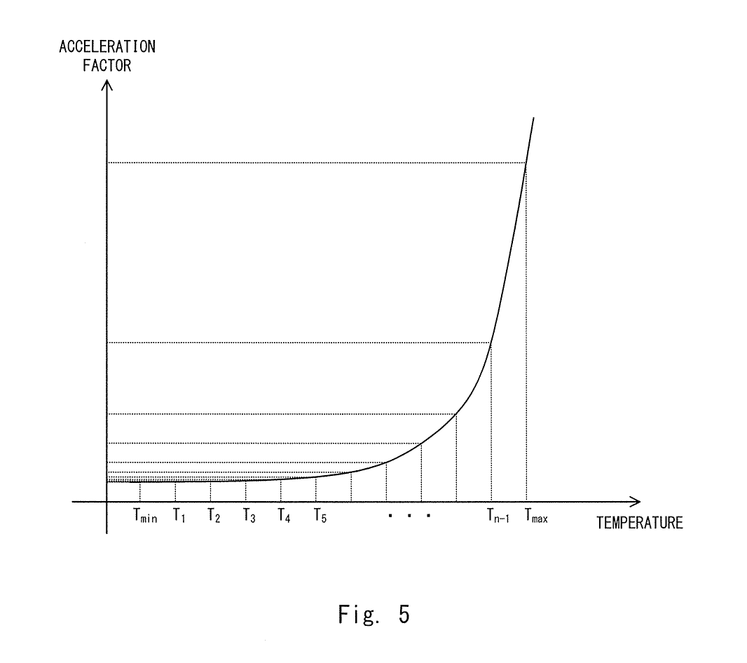

The range of values of the stressor may be equally divided as shown in FIG. 5. However, since the acceleration factor is exponentially changed, if the range of values of the stressor is equally divided, the discrepancy between the value of the acceleration factor obtained by substituting the measured value into Expression (4) and the value of the acceleration factor acquired from the look-up table 4 increases in accordance with an increase in the value of the stressor. While the relation between the temperature value and the acceleration factor is shown in FIG. 5, the relation between the voltage value and the acceleration factor is the same as the former relation. In the example in which the range of temperature values is divided as shown in FIG. 5, an increase in the temperature causes an increase in the section width of the corresponding acceleration factor. That is, when the dividing method shown in FIG. 5 is employed, the quantization error of the acceleration factor stored in the look-up table 4 increases as the value of the stressor that has been measured increases.

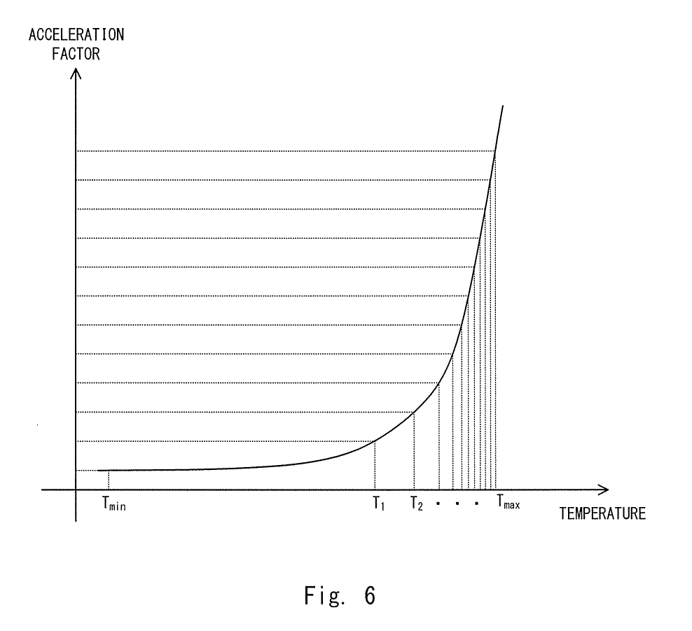

In this embodiment, as shown in FIG. 6, the range of values of the stressor is divided so that the acceleration factor is divided at regular intervals. That is, the range of values of the stressor is divided in such a way that the difference between the acceleration factors of the ranges of the divided values that are adjacent to each other becomes constant. While FIG. 6 shows the example in which the range of temperature values is divided according to this embodiment, the range of voltage values is divided in a similar way. By performing such a division, the acceleration factor can be acquired with an accuracy that does not depend on the measured value of the stressor, whereby it is possible to secure the accuracy that does not depend on the value of the stressor in the life determination of the device to be determined 9.

Such a division may be performed by solving the following expressions. In the following description, some components in Expression (4) are expressed by α and β as shown in Expressions (5) and (6).

$$\begin{matrix}α ( {T}_{x} ) = exp ( ( \frac{{E}_{a}}{k} ) ( \frac{1}{{T}_{typ}} - \frac{1}{{T}_{x}} ) ) & ( 5 ) \\ β ( {V}_{y} ) = exp ( B ( \frac{1}{{V}_{typ}} - \frac{1}{{V}_{y}} ) ) & ( 6 )\end{matrix}$$

When the range of temperature values is divided into n sections, the x-th section from the smallest value satisfies the following Expression (7). Accordingly, by solving Expression (7) for Tₓ, the boundary value of the upper limit of the temperature in the x-th section area in the look-up table 4 is calculated.

$$α ( {T}_{x} ) = \frac{( α ( {T}_{max} ) - α ( {T}_{min} ) )}{n} \cdot x \qquad ( 7 )$$

In a similar way, when the range of voltage values is divided into m sections, the y-th section from the smallest value satisfies the following Expression (8). Accordingly, by solving Expression (8) for V_{y}, the boundary value of the upper limit of the voltage in the y-th section area in the look-up table 4 is calculated.

$$β ( {V}_{y} ) = \frac{( β ( {V}_{max} ) - β ( {V}_{min} ) )}{m} \cdot y \qquad ( 8 )$$

The look-up table storage unit 15 stores the look-up table 4 thus obtained and the acceleration factor acquiring unit 142 acquires, every time the timer 13 counts the time t, the acceleration factor L_{ac}(Tₓ,V_{y}) corresponding to the measured value acquired by the measured value acquiring unit 141 by referring to the look-up table 4.

The life determining unit 143 determines whether the life of the device to be determined 9 has expired by determining whether a value L′_{ac} obtained by multiplying the accumulated value of the acceleration factors acquired by the acceleration factor acquiring unit 142 at every time t by the time t has exceeded the life L (T_{typ},V_{typ}). That is, the life determining unit 143 determines whether the following Expression (9) is satisfied. When Expression (9) is satisfied, the life determining unit 143 determines that the life of the device to be determined 9 has expired. In this embodiment, the life determining unit 143 calculates the total sum of the value of the acceleration factor L_{ac}(Tₓ,V_{y}) stored in the look-up table 4 the number of times J(Tₓ,V_{y}) counted from time 0 to the current time at every time t. Accordingly, the multiplied value L′₈ is expressed as shown in the following Expression (10).

$$\begin{matrix}L ( {T}_{typ} , {V}_{typ} ) < {L}_{ac}^{′} & ( 9 ) \\ {L}_{ac}^{′} = t \{ {L}_{ac} ( {T}_{1} , {V}_{1} ) \cdot J ( {T}_{1} , {V}_{1} ) + {L}_{ac} ( {T}_{2} , {V}_{1} ) \cdot J ( {T}_{2} , {V}_{1} ) + … + {L}_{ac} ( {T}_{max} , {V}_{max} ) \cdot J ( {T}_{max} , {V}_{max} ) ) \} & ( 10 )\end{matrix}$$

The acceleration factor acquiring unit 142 stores the number J(Tₓ,V_{y}) acquired by the acceleration factor acquiring unit 142 by the current time in the operating information storage unit 16 for each acceleration factor stored in the look-up table 4. Accordingly, in this embodiment, the life determining unit 143 determines whether the life of the device to be determined 9 has expired using the number of counts stored in the operating information storage unit 16. From the viewpoint of reducing the processing load, it is preferable to store only L′_{ac} in the operating information storage unit 16 without storing the number J(Tₓ,V_{y}), add L_{ac}(Tₓ,V_{y})×t to L′_{ac} that is stored every time the operation is performed, to thereby overwrite L′_{ac} stored in the operating information storage unit 16.

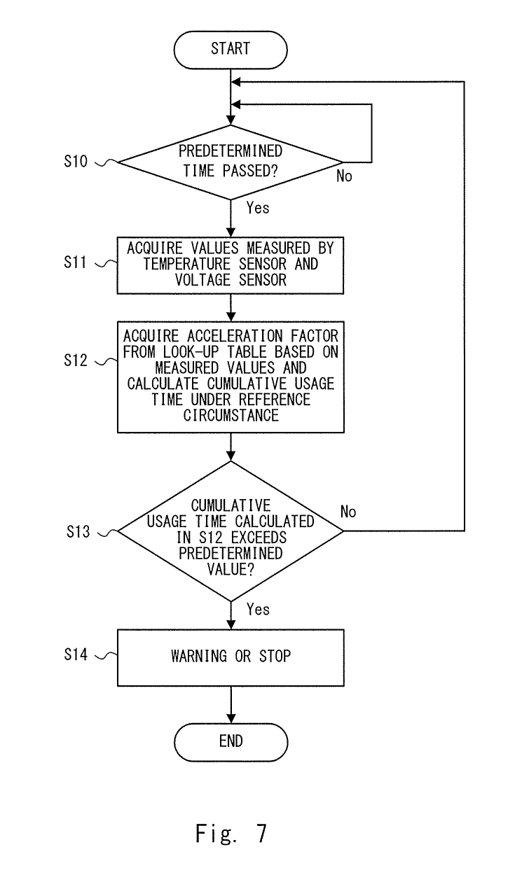

Next, an operation of the life determining device 10 will be described. FIG. 7 is a flowchart showing one example of the operation of the life determining device 10 according to this embodiment. In the following description, with reference to FIG. 7, the operation example of the life determining device 10 will be described.

In Step 10 (S10), it is determined whether the time t has been counted by the timer 13. When the timer 13 has counted the time t, the process goes to Step 11. Step 10 is repeated until the time that the timer 13 counts the time t.

In Step 11 (S11), the measured value acquiring unit 141 acquires the measured value of the temperature from the temperature sensor 11 and the measured value of the voltage from the voltage sensor 12.

In Step 12 (S12), the acceleration factor acquiring unit 142 acquires the acceleration factor corresponding to the measured values acquired in Step 11 by referring to the look-up table 4. The life determining unit 143 calculates the cumulative usage time of the device to be determined 9 under the reference circumstance. Specifically, the life determining unit 143 calculates the cumulative usage time of the device to be determined 9 under the reference circumstance from the above Expression (10).

In Step 13 (S13), the life determining unit 143 determines whether the cumulative usage time under the reference circumstance calculated in Step 12 exceeds the predetermined value. That is, the life determining unit 143 performs the determination shown in the aforementioned Expression (9). When the cumulative usage time under the reference circumstance exceeds the predetermined value, the process goes to Step 14. When the cumulative usage time under the reference circumstance does not exceed the predetermined value, the process goes back to Step 10.

In Step 14 (S14), the warning/stopping unit 144 performs control to issue the warning to the user or to stop the operation of the device to be determined 9.

The life determining device 10 according to this embodiment has been described above. In the life determining device 10 according to this embodiment, the acceleration factor acquiring unit 142 only acquires the acceleration factor from the look-up table 4 and does not need to perform the operation shown in Expression (4) at every time t. Accordingly, the processing load is suppressed.

In the above embodiment, when the life determining unit 143 determines that the life of the device to be determined 9 has expired, the warning/stopping unit 144 stops the device to be determined 9. However, since a sudden stop of the operation may cause unexpected situations and it is thus preferable to prevent failures in advance, the warning/stopping unit 144 may inform the user that the life expiration is approaching at an arbitrary time before life expires to urge the user to replace parts. Therefore, the warning/stopping unit 144 may inform the user that the life expiration is approaching when the multiplied value L′_{ac} that has been converted to be the cumulative usage time under the reference circumstance exceeds the threshold obtained by subtracting a predetermined value from the life L (T_{typ},V_{typ}). Further, the warning/stopping unit 144 may perform control to stop the operation after confirming that it will be safe even when the operation stops.

### Second Embodiment

Next, a second embodiment will be described. The values measured by the sensors such as the temperature sensor 11 and the voltage sensor 12 are not completely accurate values and include some errors with respect to actual numerical values. Therefore, when the method described in the first embodiment is employed, if the measured value of the stressor is lower than the actual value, the cumulative usage time may be underestimated.

In this embodiment, an acceleration factor value into which a value considering the accuracy guarantee of each sensor is incorporated is set in the look-up table 4 in advance. While the look-up table 4 according to the first embodiment stores the maximum value of the values of the acceleration factors for the values that belong to the range of the divided values as the acceleration factor for each range of the divided values, the look-up table 4 according to this embodiment stores a value that is larger than the maximum value of the values of the acceleration factors for the values that belong to the range of the divided values by the value corresponding to the measurement error as the acceleration factor for each range of the divided values. That is, compared to the look-up table 4 according to the first embodiment, the look-up table 4 according to this embodiment increases the value of the acceleration factor to be stored, to thereby prevent the underestimation of the cumulative usage time due to the error of the sensor.

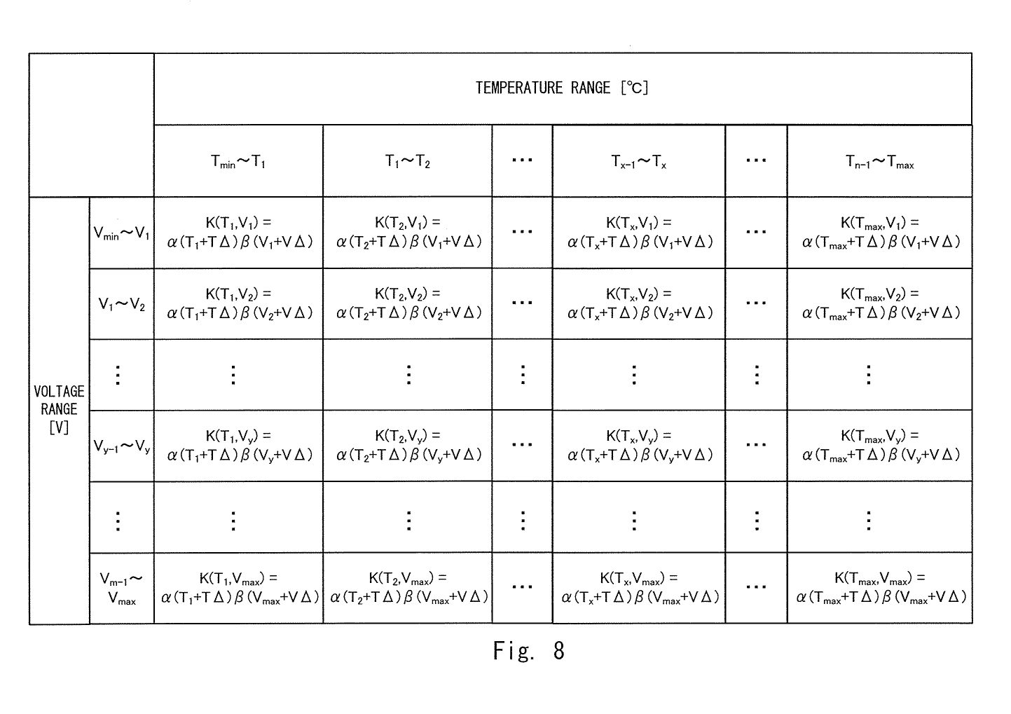

When the measurement error of the value measured by the temperature sensor 11 is ±TΔ and the measurement error of the value measured by the voltage sensor 12 is ±VΔ, the look-up table 4 according to this embodiment is set as shown in FIG. 8.

As described above, by setting the look-up table in consideration of the error of the sensor, it is possible to suppress the underestimation of the cumulative usage time.

While the error of the sensor is taken into consideration by changing the value stored in the look-up table 4 in this embodiment, the acceleration factor value stored in the look-up table 4 may be the same as that stored in the look-up table 4 according to the first embodiment and the boundaries of the segmentation of the values of the stressor may be changed. That is, a look-up table obtained by changing the look-up table 4 according to the first embodiment so that the boundary values of the segmentation are changed to be lower by the amount corresponding to the measurement error may be used in this embodiment. That is, the acceleration factor acquiring unit 142 may acquire the acceleration factor expressed as the ratio of the life of the device to be determined 9 under the reference circumstance to the life of the device to be determined 9 when the value of the stressor continues to be the value obtained by adding the value corresponding to the measurement error to the measured value acquired by the measured value acquiring unit 141. In this case as well, the value of the acceleration factor increases by the amount corresponding to the error compared to the acceleration factor value acquired by the acceleration factor acquiring unit 142 according to the first embodiment, whereby it is possible to suppress underestimation of the cumulative usage time due to the error of the sensor.

### Third Embodiment

Next, a third embodiment will be described. A life determining device according to this embodiment is different from the aforementioned embodiments in that the processing load applied to the device is controlled to be reduced when the life expiration of the device to be determined 9 approaches.

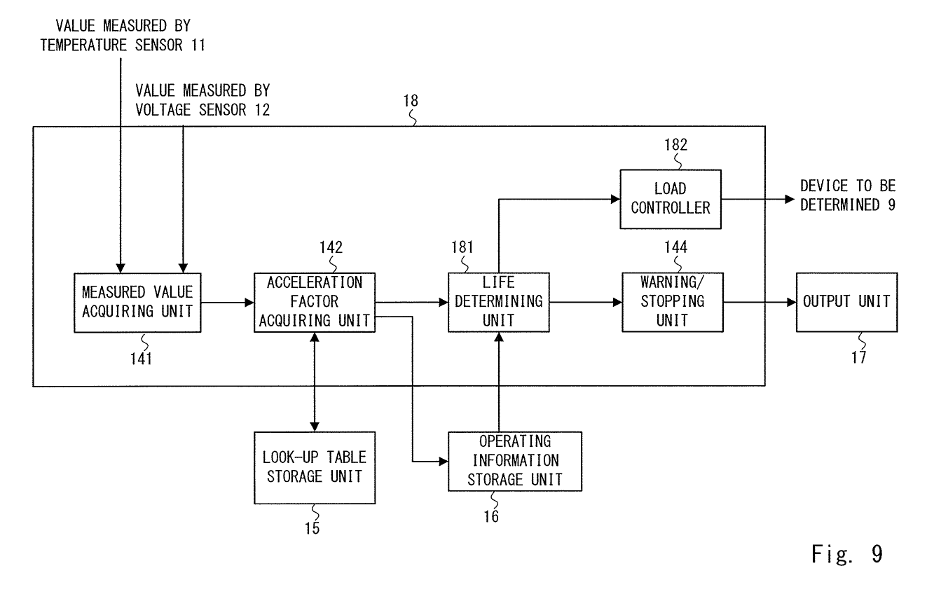

FIG. 9 is a block diagram showing a configuration of the operation unit 14. In the life determining device 10 according to this embodiment, the operation unit 14 is replaced by an operation unit 18. The operation unit 18 includes, besides the aforementioned measured value acquiring unit 141, the acceleration factor acquiring unit 142, and the warning/stopping unit 144, a load controller 182. Further, in the operation unit 18, the life determining unit 143 is replaced by a life determining unit 181.

The life determining unit 181 performs, besides the aforementioned operations of the life determining unit 143, the following operations. The life determining unit 181 determines whether the life expiration of the device to be determined 9 is approaching by determining whether the difference between the value L′_{ac} obtained by multiplying the accumulated value of the acceleration factors acquired at time t by the time t and the life L (T_{typ},V_{typ}) has become equal to or smaller than a predetermined value (margin value). When the difference between the multiplied value L′_{ac} converted to be the cumulative usage time under the reference circumstance and the life L (T_{typ},V_{typ}) becomes equal to or lower than the predetermined value, the life determining unit 181 notifies the load controller 182 that the difference between them has become equal to or lower than the predetermined value.

Upon receiving the notification from the life determining unit 181, the load controller 182 performs control to reduce the processing load of the device to be determined 9. The load controller 182 performs control, for example, to reduce the operating frequency of the device to be determined 9 or to adjust functions of the device to be determined 9.

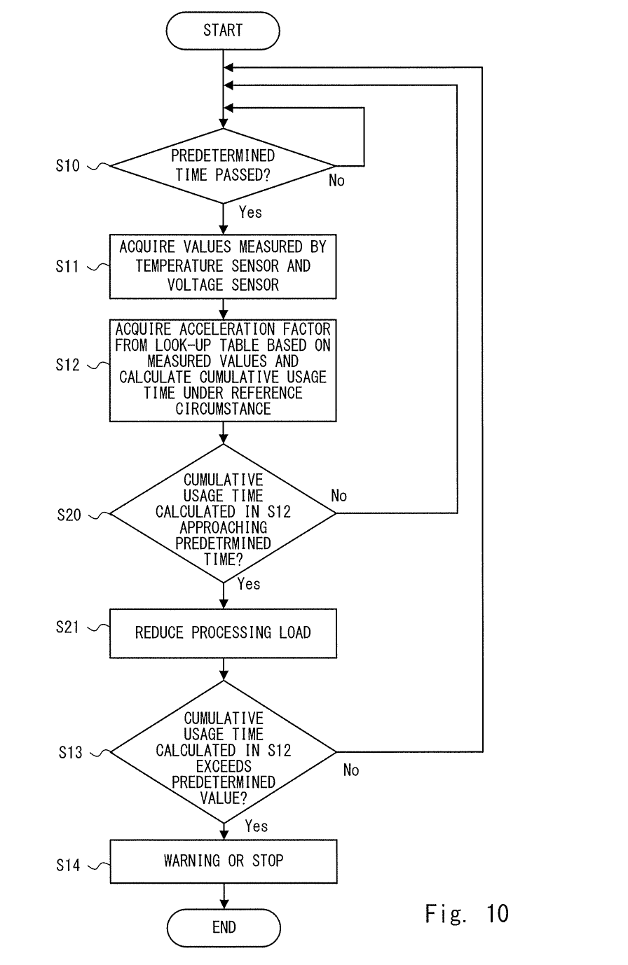

FIG. 10 is a flowchart showing one example of the operation of the life determining device 10 according to the third embodiment. Hereinafter, with reference to FIG. 10, the operation example of the life determining device 10 according to this embodiment will be described. The flowchart shown in FIG. 10 is different from the flowchart shown in FIG. 7 in that Steps 20 and 21 are added between Steps 12 and 13. In the description regarding the flowchart shown in FIG. 10, descriptions overlapping those of the flowchart shown in FIG. 7 will be omitted.

In the life determining device 10 according to this embodiment, after Step 12, the process goes to Step 20. In Step 20 (S20), the life determining unit 181 determines whether the cumulative usage time under the reference circumstance calculated in Step 12 is approaching a predetermined value indicating the life. That is, the life determining unit 181 determines whether the difference between the value L′_{ac} obtained by multiplying the accumulated value of the acceleration factors by the time t and the life L (T_{typ},V_{typ}) has become equal to or smaller than the margin value. When the difference is equal to or smaller than the margin value, the process goes to Step 21. When the difference is larger than the margin value, the process goes back to Step 10.

In Step 21 (S21), the load controller 182 performs control to reduce the processing load of the device to be determined 9. After that, the process goes to Step 13. The following operations are similar to those in the flowchart shown in FIG. 7.

According to the life determining device 10 in this embodiment, the processing load applied to the device to be determined 9 when the life expiration of the device to be determined 9 approaches is reduced. Accordingly, it is possible to extend the actual operating time until the time that the life of the device to be determined 9 actually expires while reducing the risk of the failure of the device to be determined 9.

While the invention made by the present inventors has been specifically described based on the embodiments, it is needless to say that the present invention is not limited to the embodiments already stated above and various changes may be made on the embodiments without departing from the spirit of the present invention.

The first to third embodiments can be combined as desirable by one of ordinary skill in the art.

While the invention has been described in terms of several embodiments, those skilled in the art will recognize that the invention can be practiced with various modifications within the spirit and scope of the appended claims and the invention is not limited to the examples described above.

Further, the scope of the claims is not limited by the embodiments described above.

Furthermore, it is noted that, Applicant's intent is to encompass equivalents of all claim elements, even if amended later during prosecution.

What is claimed is:

1. A life determining device comprising:
a measured value acquiring unit that acquires, as a measured value of a stressor of a device whose life is to be determined, measured values of a temperature and a voltage of the device at predetermined time intervals;
an acceleration factor acquiring unit that acquires a first acceleration factor, which is the ratio of a second life to a first life, at the predetermined time intervals; and
a life determining unit that determines life expiration of the device whose life is to be determined by comparing a value obtained by multiplying an accumulated value of the first acceleration factor acquired by the acceleration factor acquiring unit by the predetermined time with the second life, wherein:
the first life is a life of the device whose life is to be determined when the value of the stressor continues to be the measured value acquired by the measured value acquiring unit,
the second life is a life of the device whose life is to be determined when the value of the stressor continues to be a reference value, and
the acceleration factor acquiring unit uses a look-up table that stores a second acceleration factor for every predetermined value when the acceleration factor acquiring unit acquires the first acceleration factor, the second acceleration factor being the ratio of the second life to the life of the device whose life is to be determined when the value of the stressor of the device whose life is to be determined continues to be a predetermined value.

2. The life determining device according to claim 1, wherein the look-up table stores, for each range of divided values in which a range of values from a first value to a second value of the stressor of the device whose life is to be determined is divided, one second acceleration factor for each value that belongs to the range of the divided values.

3. The life determining device according to claim 2, wherein the range of values is divided so that a difference between second acceleration factors of the ranges of the divided values that are adjacent to each other becomes constant.

4. The life determining device according to claim 2, wherein the look-up table stores, as the second acceleration factor for each range of the divided values, a maximum value of values of the second acceleration factors for values that belong to the range of the divided values.

5. The life determining device according to claim 2, wherein the first value is a lower-limit value of a guaranteed value of the device whose life is to be determined and the second value is an upper-limit value of the guaranteed value of the device whose life is to be determined.

6. The life determining device according to claim 2, wherein the look-up table stores, as the second acceleration factor for each range of the divided values, a value larger than a maximum value of values of the second acceleration factors for values that belong to the range of the divided values by an amount corresponding to a measurement error of the measured value.

7. The life determining device according to claim 1, wherein the first life is a life of the device whose life is to be determined when the value of the stressor continues to be a value obtained by adding a value corresponding to a measurement error to the measured value acquired by the measured value acquiring unit.

8. The life determining device according to claim 1, wherein the measured value acquiring unit further acquires, as a measured value of the stressor of the device whose life is to be determined, a measured value of a humidity or a current of the device.

9. The life determining device according to claim 1, further comprising a load controller that performs control to reduce a processing load of the device whose life is to be determined when it is determined by the life determining unit that the difference between the multiplied value and the second life becomes equal to or smaller than a predetermined value.

10. The life determining device according to claim 1, further comprising:
a temperature sensor that measures a temperature of the device whose life is to be determined;
a voltage sensor that measures a voltage of the device whose life is to be determined; and
a timer, wherein:
the measured value acquiring unit acquires measured values from the temperature sensor and the voltage sensor as the measured value of the stressor of the device whose life is to be determined every time the timer counts a predetermined time interval, and
the acceleration factor acquiring unit acquires the first acceleration factor every time the timer counts the predetermined time interval.

11. A life determining method comprising:
a measured value acquisition step for acquiring, as a measured value of a stressor of a device whose life is to be determined, measured values of a temperature and a voltage for the device at predetermined time intervals,
an acceleration factor acquisition step for acquiring a first acceleration factor, which is the ratio of a second life to a first life, at the predetermined time intervals; and
a life determination step for determining a life expiration of the device whose life is to be determined by comparing a value obtained by multiplying an accumulated value of the first acceleration factor acquired in the acceleration factor acquisition step by the predetermined time with the second life, wherein:
the first life is a life of the device whose life is to be determined when the value of the stressor continues to be the measured value acquired in the measured value acquisition step,
the second life is a life of the device whose life is to be determined when the value of the stressor continues to be a reference value, and
in the acceleration factor acquisition step, the first acceleration factor is acquired using a look-up table that stores a second acceleration factor, which is the ratio of the second life to the life of the device whose life is to be determined when the value of the stressor of the device whose life is to be determined continues to be a predetermined value for each predetermined value.
